(19) United States
(12) Patent Application Publication
(10) Pub. No.: US 2004/0038103 A1
(43) Pub. Date: Feb. 26, 2004

(54) Solid polymer electrolyte fuel cell assembly

(75) Inventors: Yoshinori Wariishi, Utsunomiya-shi (JP); Hideaki Kikuchi, Kawachi-gun (JP); Yuichiro Kosaka, Utsunomiya-shi (JP); Yosuke Fujii, Kawachi-gun (JP); Masahiro Ise, Utsunomiya-shi (JP); Seiji Sugiura, Utsunomiya-shi (JP)

Correspondence Address: LAHIVE & COCKFIELD, LLP., 28 STATE STREET, BOSTON, MA, 02109, US

(73) Assignee: Honda Giken Kogyo Kabushiki Kaisha, Tokyo (JP)

(21) Appl. No.: 10/641,592

(22) Filed: Aug. 15, 2003

(30) Foreign Application Priority Data
Aug. 23, 2002 (JP) 2002-243798

(51) Int. Cl. H01M 8/02; H01M 8/10; H01M 8/04; H01M 8/24

(52) U.S. Cl. 429/32; 429/26; 429/38; 429/39

(57) ABSTRACT

A cell assembly is formed by stacking a first fuel cell and a second fuel cell together. The first fuel cell has a first membrane electrode assembly, and the second fuel cell has a second membrane electrode assembly. In the cell assembly, oxygen-containing gas flow fields of the first and second separators are connected in series, and fuel gas flow fields of the first and second separators are connected in series. Coolant flow fields are formed on opposite sides of the cell assembly, respectively, for supplying a coolant straight in one direction through the coolant flow fields.

### BACKGROUND OF THE INVENTION

1. Field of the Invention

The present invention relates to a solid polymer electrolyte fuel cell assembly formed by stacking a plurality of fuel cells together. Each of the fuel cells includes an anode, a cathode, and a solid polymer electrolyte membrane interposed between the anode and the cathode.

2. Description of the Related Art

Generally, a solid polymer electrolyte fuel cell employs a membrane electrode assembly (MEA) which comprises two electrodes (anode and cathode) and an electrolyte membrane interposed between the electrodes. The electrolyte membrane is a polymer ion exchange membrane. Each of the electrodes is chiefly made of a carbon. The membrane electrode assembly is interposed between separators (bipolar plates). The membrane electrode assembly and the separators make up a unit of the fuel cell for generating electricity. A predetermined number of fuel cells are stacked together to form a fuel cell stack.

In the fuel cell, a fuel gas such as a hydrogen-containing gas is supplied to the anode. The catalyst of the anode induces a chemical reaction of the fuel gas to split the hydrogen molecule into hydrogen ions (protons) and electrons. The hydrogen ions move toward the cathode through the electrolyte, and the electrons flow through an external circuit to the cathode, creating a DC electric current. An oxygen-containing gas or air is supplied to the cathode. At the cathode, the hydrogen ions from the anode combine with the electrons and oxygen to produce water.

When the fuel cell stack is mounted on a vehicle for supplying electric energy to the vehicle, the fuel cell stack is required to produce a relatively large output. In order to produce the large output, for example, it is suggested to use fuel cells having reaction surfaces (power generation surfaces) of large dimensions, and to stack a large number of the fuel cells to form the fuel cell stack.

However, if the dimensions of the fuel cells are large, the size of the overall fuel cell stack is large. The large fuel cell stack is not suitable for the vehicle application. Therefore, in most cases, a large number of relatively small fuel cells are stacked together to form the fuel cell stack. When a large number of fuel cells are used to form the fuel cell stack, the temperature differences may occur undesirably in the stacking direction of the fuel cells. Further, the water produced in the electrochemical reaction of the fuel cells may not be discharged from the fuel cell stack smoothly. Consequently, the desired power generation performance is not achieved.

### SUMMARY OF THE INVENTION

A main object of the present invention is to provide a solid polymer electrolyte fuel cell assembly having a simple and compact structure in which the power generation performance of fuel cells is effectively improved.

According to the present invention, a solid polymer electrolyte fuel cell assembly is formed by stacking a plurality of fuel cells together. Each of the fuel cells has a membrane electrode assembly including an anode, a cathode, and a solid polymer electrolyte membrane interposed between the anode and the cathode. In the cell assembly, reactant gas flow fields extend through the fuel cells, respectively, for supplying a reactant gas to the fuel cells. The reactant gas includes at least one of a fuel gas and an oxygen-containing gas. The reactant gas flow fields are connected in series at least partially. The expression “at least partially” herein is intended to include the following two cases.

1. Assuming that a plurality of reactant gas flow fields extend through each of the fuel cells, at least one of the reactant gas flow fields extending through one fuel cell is connected to at least one of the reactant gas flow fields extending through another fuel cell.

2. Assuming that one reactant gas flow field extends through each of the fuel cells, at least a part of the reactant gas flow field extending through one fuel cell is connected to at least a part of the reactant gas flow field extending through another fuel cell.

In this system, the amount of the reactant gas supplied to the fuel cell on the upstream side is sufficient for reactions in the fuel cells in the upstream side and the downstream side. Therefore, the amount, i.e., the flow rate of the reactant gas supplied to the cell assembly is large. Consequently, the humidity, and the current density distribution are uniform in each of the fuel cells. It is possible to reduce the concentration overpotential. The flow rate of the reactant gas supplied to the cell assembly is increased, and thus, the water produced in each of the fuel cells is efficiently discharged from the overall cell assembly.

In the cell assembly, the reactant gas flow fields extending through the fuel cells are connected to form a long reactant gas flow field. Consequently, the reactant gas is uniformly distributed to each of the fuel cells. The cell assembly can be used as a single component assembled into the fuel cell stack. The number of components (cell assemblies) assembled into the fuel cell stack is small. The assembling operation is simplified in comparison with the conventional fuel cell system in which a large number of fuel cells are assembled into the fuel cell stack.

Further, coolant flow fields may be formed on opposite sides of the cell assembly, respectively, for supplying a coolant straight in one direction through the coolant flow fields. Alternatively, a coolant flow field may extend through the cell assembly for supplying a coolant straight through the coolant flow field. Since the coolant flows through the coolant flow fields in the one direction smoothly, the cooling efficiency is good, and the temperature difference does not occur in the cell assembly, or between the cell assemblies. The power generation performance in the fuel cells is not degraded, and the desired power generation performance of the overall cell assembly is reliably maintained.

Further, wall plates may be formed on opposite sides of the cell assembly, respectively. Alternatively, a wall plate may extend through the cell assembly. The coolant flow fields are formed on both sides of the wall plates for supplying the coolant in parallel through the coolant flow fields. Therefore, the fuel cells on both sides of the wall plate are cooled efficiently.

The above and other objects, features and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is an exploded perspective view showing main components of a solid polymer electrolyte fuel cell assembly according to a first embodiment of the present invention;

FIG. 2 is a perspective view schematically showing a fuel cell stack;

FIG. 3 is a cross sectional view showing a part of the cell assembly;

FIG. 4 is a front view showing a first separator of the cell assembly;

FIG. 5 is an exploded perspective view showing fluid flows in the cell assembly;

FIG. 6 is an exploded perspective view showing main components of a solid polymer electrolyte fuel cell assembly according to a second embodiment of the present invention;

FIG. 7 is an exploded perspective view showing fluid flows in the cell assembly according to the second embodiment; and

FIG. 8 is an exploded perspective view showing fluid flows in a solid polymer electrolyte fuel cell assembly according to a third embodiment of the present invention.

### DESCRIPTION OF THE PREFERRED EMBODIMENTS

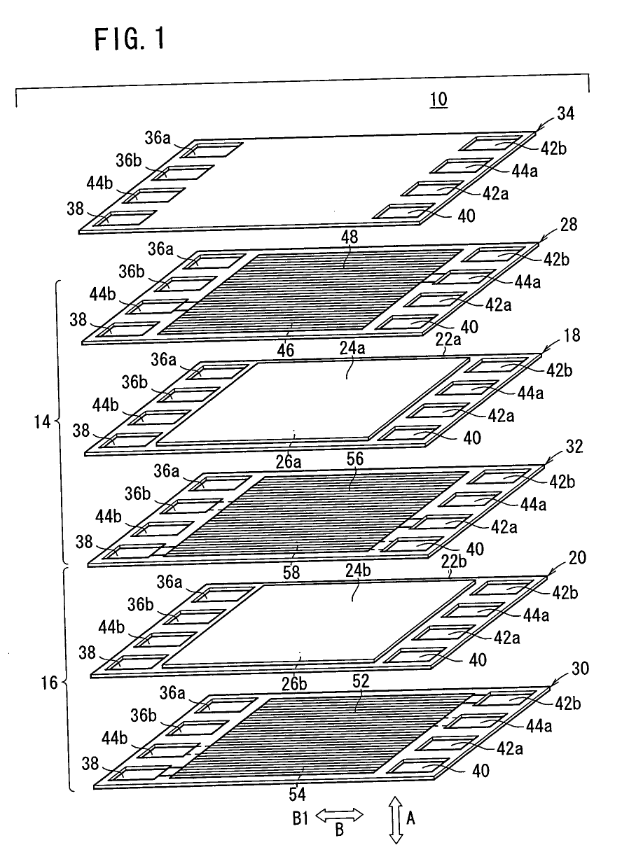

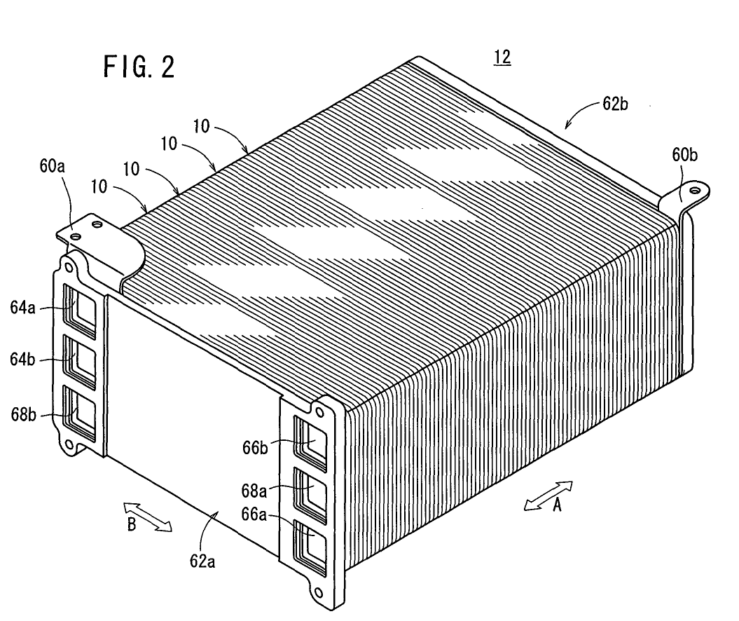

FIG. 1 is an exploded perspective view showing main components of a solid polymer electrolyte fuel cell assembly 10 according to a first embodiment of the present invention. FIG. 2 is a perspective view schematically showing a fuel cell stack 12 formed by stacking (connecting) a plurality of the cell assemblies 10 together.

As shown in FIG. 1, the cell assembly 10 is formed by stacking a first fuel cell 14 and a second fuel cell 16. The first fuel cell 14 includes a first membrane electrode assembly 18, and the second fuel cell 16 includes a second membrane electrode assembly 20.

The first membrane electrode assembly 18 includes an anode 26a, a cathode 24a, and a solid polymer electrolyte membrane 22a interposed between the anode 26a and the cathode 24a. The second membrane electrode assembly 20 includes an anode 26b, a cathode. 24b, and a solid polymer electrolyte membrane 22b interposed between the anode 26b and the cathode 24b.

Each of the anodes 26a, 26b and the cathode 24a, 24b has a porous gas diffusion layer 42a, 42b such as a porous carbon paper, and an electrode catalyst layer 44a, 44b of noble metal supported on a carbon based material.

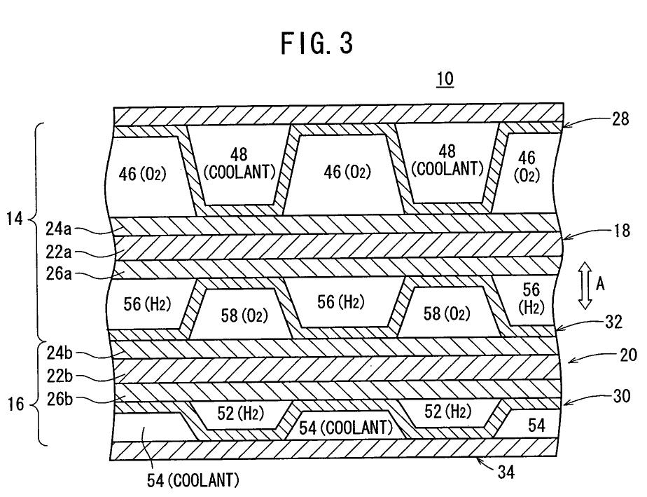

As shown in FIGS. 1 and 3, a first separator 28 is provided adjacent to the cathode 24a of the first membrane electrode assembly 18, and a second separator 30 is provided adjacent to the anode 26b of the second membrane electrode assembly 20. Further, an intermediate separator 32 is interposed between the first membrane electrode assembly 18 and the second membrane electrode assembly 20. Thin wall plates 34 are provided outside the first separators 28, 30. The wall plate 34 is interposed between the adjacent cell assemblies 10.

As shown in FIG. 1, at one end of the first and second fuel cells 14, 16 in a longitudinal direction indicated by an arrow B, an oxygen-containing gas supply passage 36a as a passage of an oxygen-containing gas (reactant gas) such as air, an oxygen-containing gas discharge passage 36b as a passage of the oxygen-containing gas, a coolant discharge passage 44b as a passage of a coolant, and an intermediate fuel gas passage 38 as a passage of a fuel gas (reactant gas) such as a hydrogen-containing gas are formed. The oxygen-containing gas supply passage 36a, the oxygen-containing gas discharge passage 36b, the coolant discharge passage 44b, and the intermediate fuel gas passage 38 extend through the cell assembly 10 in a stacking direction indicated by an arrow A.

At the other end of the first and second fuel cells 14, 16 in the longitudinal direction, an intermediate oxygen-containing gas passage 40 as a passage of the oxygen-containing gas, a fuel gas supply passage 42a as a passage of the fuel gas, a coolant supply passage 44a as a passage of the coolant, and a fuel gas discharge passage 42b as a passage of the fuel gas are formed. The intermediate oxygen-containing gas passage 40, the fuel gas supply passage 42a, the coolant supply passage 44a, and the fuel gas discharge passage 42b extend through the cell assembly 10 in the direction indicated by the arrow A.

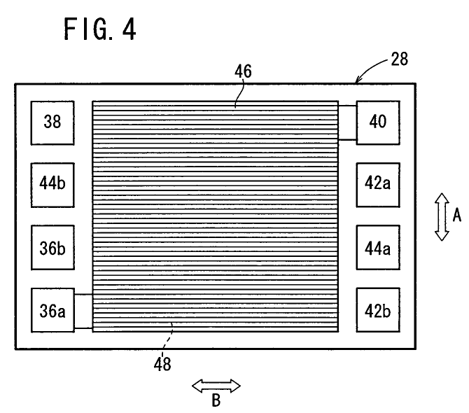

The first separator 28 is a thin metal plate, and has an uneven surface (e.g., wave-shaped surface) facing a reaction surface (power generation surface) of the first membrane electrode assembly 18. As shown in FIGS. 3 and 4, the first separator 28 has an oxygen-containing gas flow field (reactant gas flow field) 46 on its surface facing the cathode 24a of the first membrane electrode assembly 18. The oxygen-containing gas flow field 46 comprises a plurality of grooves extending straight in the longitudinal direction indicated by the arrow B. The oxygen-containing gas flow field 46 is connected to the oxygen-containing gas supply passage 36a at one end, and connected to the intermediate oxygen-containing gas passage 40 at the other end.

As shown in FIGS. 1 and 3, the first separator 28 has a coolant flow field 48 on its surface facing the wall plate 34. The coolant flow field 48 comprises a plurality of grooves extending straight in the longitudinal direction indicated by the arrow B. The coolant flow filed 48 is connected to the coolant supply passage 44a at one end, and connected to the coolant discharge passage 44b at the other end.

The second separator 30 has substantially the same structure as the first separator 28. The second separator 30 has a fuel gas flow field (reactant gas flow field) 52 on its surface facing the anode 26b of the second membrane electrode assembly 20. The fuel gas flow field 52 comprises a plurality of grooves extending straight in the longitudinal direction indicated by the arrow B. The fuel gas flow field 52 is connected to the intermediate fuel gas passage 38 at one end, and connected to the fuel gas discharge passage 42b at the other end. Further, the second separator 30 has a coolant flow field 54 on its surface facing the wall plate 34. The coolant flow field 54 comprises a plurality of groves extending straight in the longitudinal direction indicated by the arrow B. The coolant flow field 54 is connected to the coolant supply passage 44a at one end, and connected to the coolant discharge passage 44b at the other end.

The intermediate separator 32 has substantially the same structure as the first and second separators 28, 30. The intermediate separator 32 has a fuel gas flow field (reactant gas flow field) 56 on its surface facing the anode 26a of the first membrane electrode assembly 18. The fuel gas flow field 56 comprises a plurality of grooves extending straight in the longitudinal direction indicated by the arrow B. The fuel gas flow field 56 is connected to the fuel gas supply passage 42a at one end, and connected to the intermediate fuel gas passage 38 at the other end.

As shown in FIG. 3, the intermediate separator 32 has an oxygen-containing gas flow field (reactant gas flow field) 58 on its surface facing the cathode 24b of the second membrane electrode assembly 20. The oxygen-containing gas flow field 58 comprises a plurality of grooves extending straight in the longitudinal direction indicated by the arrow B. The oxygen-containing gas flow field 58 is connected to the intermediate oxygen-containing gas passage 40 at one end and the oxygen-containing gas discharge passage 36b at the other end.

The oxygen-containing gas flow field 46 of the first fuel cell 14 is connected in series to the oxygen-containing gas flow field 58 of the second fuel cell 16. The cross sectional area of the oxygen-containing gas flow field 46 is different from the cross sectional area of the oxygen-containing gas flow field 58. The fuel gas flow field 56 of the first fuel cell 14 is connected in series to the fuel gas flow field 52 of the second fuel cell 16. The cross sectional area of the fuel gas flow field 56 is different from the cross sectional area of the fuel gas flow field 52. As shown in FIG. 3, the cross sectional area of the oxygen-containing gas flow field 58, and the cross sectional area of the fuel gas flow field 52 near the outlet side of the cell assembly 10 are smaller than the cross sectional area of the oxygen-containing gas flow field 46 and the cross sectional area of the fuel gas flow field 56 near the inlet side of the cell assembly 10, respectively.

As shown in FIG. 2, a predetermined number of the cell assemblies 10 are fixed together using fixing means (not shown), i.e., stacked together in the direction indicated by the arrow A. Terminal plates 60a, 60b are stacked on the outside of outermost cell assemblies 10, respectively. Further, end plates 62a, 62b are stacked on the outside of the terminal plates 60a, 60b, respectively. The cell assemblies 10 and the terminal plates 60a, 60b are fastened together to form the fuel cell stack 12 by tightening the end plates 62a, 62b with an unillustrated tie rod or the like.

At one longitudinal end of the end plate 62a, an oxygen-containing gas supply port 64a, an oxygen-containing gas discharge port 64b, and a coolant discharge port 68b are formed. The oxygen-containing gas supply port 64a is connected to the oxygen-containing gas supply passage 36a, and the oxygen-containing gas discharge port 64b is connected to the oxygen-containing gas discharge passage 36b. The coolant discharge port 68b is connected to the coolant discharge passage 44b. At the other longitudinal end of the end plate 62a, a fuel gas supply port 66a, a fuel gas discharge port 66b, and a coolant supply port 68a are formed. The fuel gas supply port 66a is connected to the fuel gas supply passage 42a, and the fuel gas discharge port 66b is connected to the fuel gas discharge passage 42b. The coolant supply port 68a is connected to the coolant supply passage 44a.

Next, operation of the cell assembly 10 will be described below.

In the fuel cell stack 12, an oxygen-containing gas such as air is supplied to the oxygen-containing gas supply port 64a, a fuel gas such as a hydrogen-containing gas is supplied to the fuel gas supply port 66a, and a coolant such as pure water, ethylene glycol or an oil is supplied to the coolant supply port 68a. From the oxygen-containing gas supply port 64a, the fuel gas supply port 66a, and the coolant supply port 68a, the oxygen-containing gas, the fuel gas, and the coolant are supplied to each of the cell assemblies 10 stacked together in the direction indicated by the arrow A to form the fuel cell stack 12.

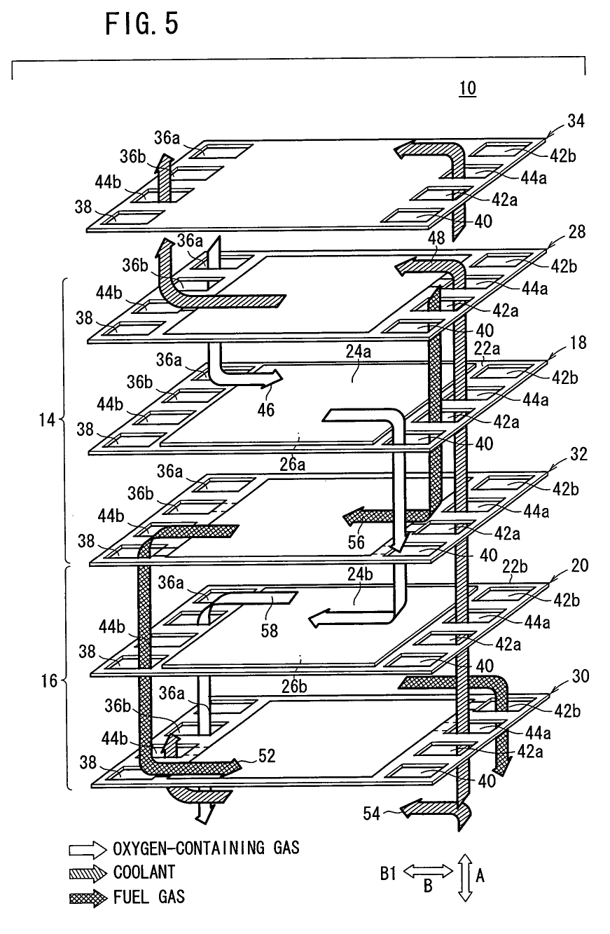

As shown in FIG. 5, the oxygen-containing gas flows through the oxygen-containing gas supply passage 36a in the direction indicated by the arrow A, and flows into the grooves of the oxygen-containing gas flow field 46 formed on the first separator 28. The oxygen-containing gas in the oxygen-containing gas flow field 46 flows along the cathode 24a of the first membrane electrode assembly 18 to induce a chemical reaction at the cathode 24a. The fuel gas flows through the fuel gas supply passage 42a, and flows into the grooves of the fuel gas flow field 56 formed on the intermediate separator 32. The fuel gas in the fuel gas flow field 56 flows along the anode 26a of the first membrane electrode assembly 18 to induce a chemical reaction at the anode 26a. In the first membrane electrode assembly 18, the oxygen-containing gas supplied to the cathode 24a, and the fuel gas supplied to the anode 26a are consumed in the electrochemical reactions at catalyst layers of the cathode 24a and the anode 26a for generating electricity.

Oxygen in the oxygen-containing gas is partially consumed in the chemical reaction in the first membrane electrode assembly 18. The oxygen-containing gas flows out of the oxygen-containing gas flow field 46, flows through the intermediate oxygen-containing gas passage 40 in the direction indicated by the arrow A, and flows into the oxygen-containing gas flow field 58 formed on the intermediate separator 32. The oxygen-containing gas in the oxygen-containing gas flow passage 58 flows along the cathode 24b of the second membrane electrode assembly 20 to induce a chemical reaction at the cathode 24b.

Similarly, hydrogen in the fuel gas is partially consumed in the chemical reaction at the anode 26a of the first membrane electrode assembly 18. The fuel gas flows through the intermediate fuel gas passage 38 in the direction indicated by the arrow A, and flows into the fuel gas flow passage 52 formed on the second separator 30. The fuel gas in the fuel gas flow passage 52 flows along the anode 26b of the second membrane electrode assembly 20 to induce a chemical reaction at the anode 26b. In the second membrane electrode assembly 20, the oxygen-containing gas and the fuel gas are consumed in the electrochemical reactions at catalyst layers of the cathode 24b and the anode 26b for generating electricity. After oxygen is consumed, the oxygen-containing gas flows out of the oxygen-containing gas flow field 58, and flows into the oxygen-containing gas discharge passage 36b. After hydrogen is consumed, the fuel gas flows out of the fuel gas flow field 52, and flows into the fuel gas discharge passage 42b.

The coolant flows through the coolant supply passage 44a, and flows along the coolant flow field 48 between the wall plate 34 and the first separator 28, and the coolant flow field 54 between the wall plate 34 on the opposite side and the second separator 30. The wall plate 34 is interposed between the adjacent cell assemblies 10. Therefore, the coolant flows straight between the adjacent cell assemblies 10 in one direction for cooling the cell assemblies 10.

In the first embodiment, the first fuel cell 14 and the second fuel cell 16 are stacked together to form the cell assembly 10. The oxygen-containing gas flow field 46 and the oxygen-containing gas flow field 58 are connected in series at least partially by the intermediate oxygen-containing gas passage 40. The fuel gas flow field 56 and the fuel gas flow field 52 are connected in series at least partially by the intermediate fuel gas passage 38.

Therefore, the amount of the oxygen-containing gas and the amount of the fuel gas supplied to the respective oxygen-containing gas flow field 46 and the fuel gas flow field 56 near the inlet side of the cell assembly 10 are large since the oxygen-containing gas and the fuel gas are used for the reactions in both of the first fuel cell 14 and the second fuel cell 16. The amount of the oxygen-containing gas and the amount of the fuel gas supplied to the respective oxygen-containing gas flow field 46 and the fuel gas flow field 56 are twice as much as the amount of the oxygen-containing gas and the amount of the fuel gas supplied the ordinary fuel cell.

Therefore, the water produced in the oxygen-containing gas flow field 46, and the oxygen-containing gas flow field 58 is smoothly discharged from the cell assembly 10. Thus, the humidity is uniform in each of the oxygen-containing gas flow field 46 of the first fuel cell 14 and the oxygen-containing gas flow field 58 of the second fuel cell 16. Consequently, the current density distribution is uniform in each of the first and second fuel cells 14, 16. It is possible to reduce the concentration overpotential.

The oxygen-containing gas flow field 46 of the first fuel cell 14 is connected in series to the oxygen-containing gas flow field 58 of the second fuel cell 16. The fuel gas flow field 56 of the first fuel cell 14 is connected in series to the fuel gas flow field 52 of the second fuel cell 16. Therefore, the flow rate of the oxygen-containing gas supplied to the oxygen-containing gas supply passage 36a and the flow rate of the fuel gas supplied to the fuel gas supply passage 42a are increased in comparison with the case of the conventional fuel cell. Therefore, the water produced in the first and second fuel cells 14, 16 is efficiently discharged from the cell assembly 10.

The oxygen-containing gas flow field 46 extending through the first fuel cell 14 is connected to the oxygen-containing gas flow field 58 extending through the second fuel cell 16, and the fuel gas flow field 56 extending through the first fuel cell 14 is connected to the fuel gas flow field 52 extending through the second fuel cell 16 to form long reactant gas flow fields. Consequently, the oxygen-containing gas and the fuel gas are uniformly distributed to each of the cell assemblies 10 of the fuel cell stack 12.

In the first embodiment, as shown in FIG. 5, the coolant from the coolant supply passage 44a flows straight through the coolant flow field 48 of the first separator 28, and flows straight through the coolant flow field 54 of the second separator 30 in the same direction indicated by an arrow B1. Then, the coolant flows into the coolant discharge passage 44b. The coolant flows through the cell assemblies 10 smoothly. The cooling efficiency is good, and the temperature difference does not occur between the cell assemblies 10. The power generation performance in the first and second fuel cells 14, 16 is not degraded, and the desired power generation performance of the overall cell assembly 10 is reliably maintained.

In the first embodiment, a plurality of, e.g., two fuel cells 14, 16 are stacked together to form the cell assembly 10. The cell assembly 10 can be used as a single component assembled into the fuel cell stack 12. Therefore, the number of components (cell assemblies 10) assembled into fuel cell stack 12 is small. The assembling operation is simplified in comparison with the conventional fuel cell system in which a large number of fuel cells are assembled into a fuel cell stack.

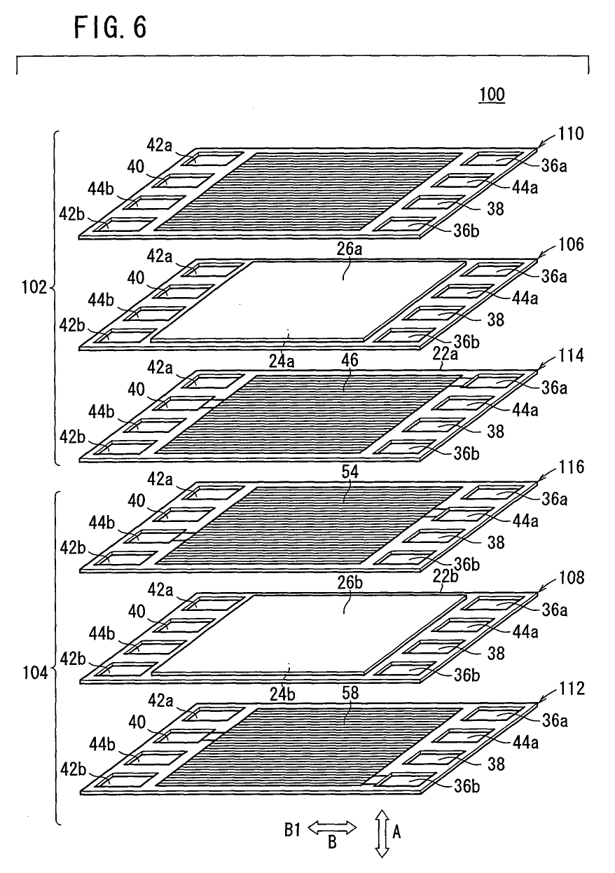

FIG. 6 is an exploded perspective view showing main components of a solid polymer electrolyte fuel cell assembly according to a second embodiment of the present invention. In FIG. 6, the constituent elements that are identical to those of the cell assembly 10 according to the first embodiment are labeled with the same reference numeral, and description thereof is omitted.

The cell assembly 100 is formed by stacking a first fuel cell 102 and a second fuel cell 104. The first cell 102 includes a first membrane electrode assembly 106, and the second fuel cell 16 includes a second membrane electrode assembly 108. The first membrane electrode assembly 106 is interposed between a first separator 100 and a first intermediate separator 114. The second membrane electrode assembly 108 is interposed between a second separator 112 and a second intermediate separator 110.

At one end of the cell assembly 100 in a longitudinal direction, a fuel gas supply passage 42a, an intermediate oxygen-containing gas passage 40, a coolant discharge passage 44b, and a fuel gas discharge passage 42b are formed. The fuel gas supply passage 42a, the intermediate oxygen-containing gas passage 40, the coolant discharge passage 44b, and the fuel gas discharge passage 42b extend through the cell assembly 100 in a direction indicated by an arrow A. At the other end of the cell assembly 100 in the longitudinal direction, an oxygen-containing gas supply passage 36a, a coolant supply passage 44a, an intermediate fuel gas passage 38, and an oxygen-containing gas discharge passage 36b are formed. The oxygen-containing gas supply passage 36a, the coolant supply passage 44a, the intermediate fuel gas passage 38, and the oxygen-containing gas discharge passage 36b extend through the cell assembly 100 in the direction indicated by the arrow A. A coolant flow field 54 is formed by a surface of the first intermediate separator 114, and a surface of the second intermediate separator 116, i.e., between the first and second intermediate separators 114, 116. The coolant flow field 54 is connected to the coolant supply passage 44a at one end, and connected to the coolant discharge passage 44b at the other end. The coolant flows straight through the coolant flow field 54 in the direction indicated by an arrow B1.

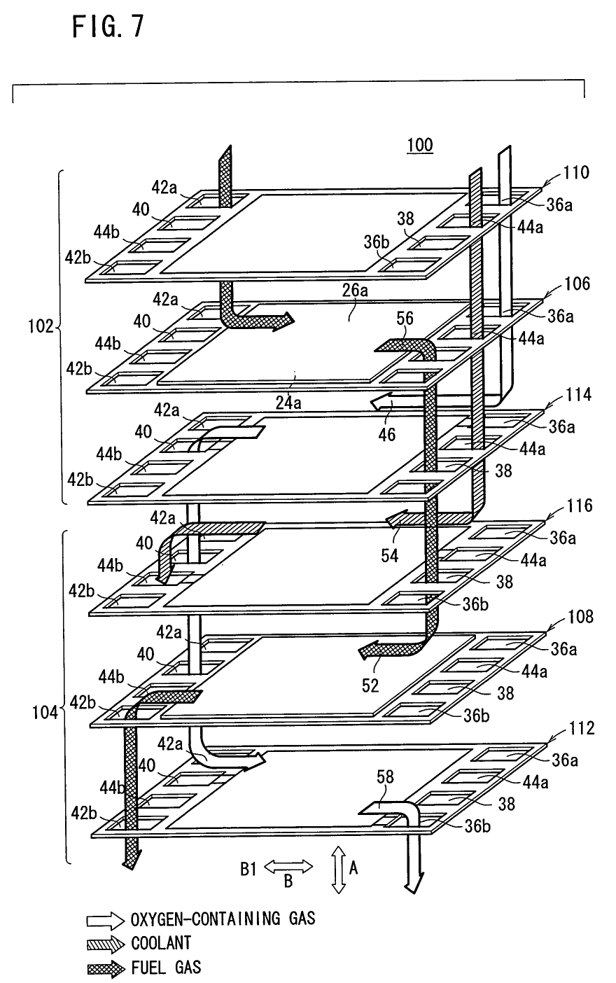

In the cell assembly 100, the oxygen-containing gas, the fuel gas, and the coolant flow in the directions shown in FIG. 7, and are supplied serially to the first and second fuel cells 102, 104. The coolant flows in the direction indicated by the arrow B1 through the coolant flow field 54 extending straight between the first fuel cell 102 and the second fuel cell 104 (in the cell assembly 100). Therefore, the cooling efficiency is good, and the temperature difference does not occur in the cell assembly 100. The power generation performance in the first and second fuel cells 102, 104 is not degraded, and the desired power generation performance of the overall cell assembly 100 is reliably maintained as with the first embodiment.

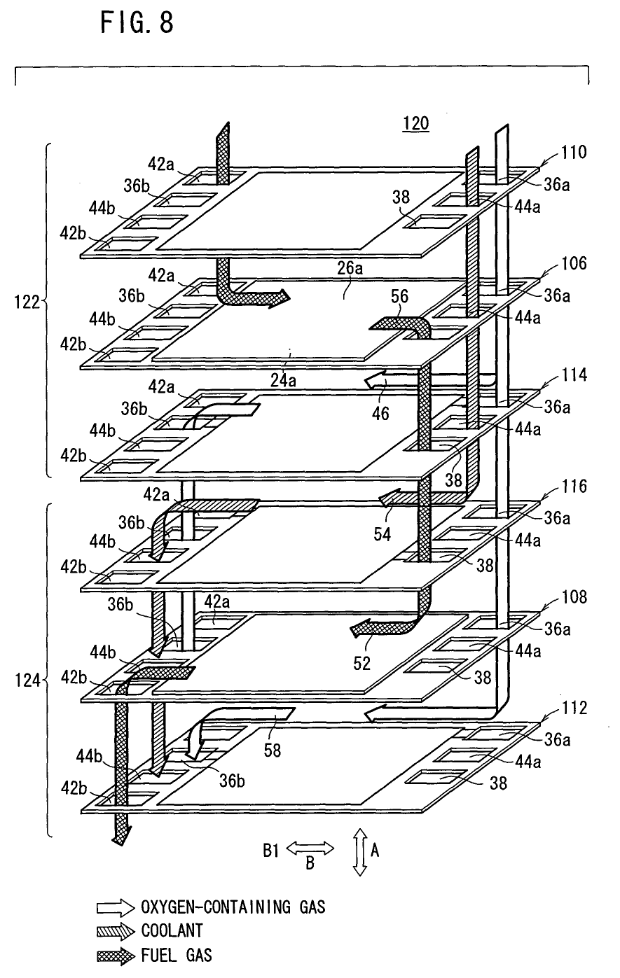

FIG. 8 is an exploded perspective view showing fluid flows in a solid polymer electrolyte fuel cell assembly 120 according to a third embodiment of the present invention. In FIG. 8, the constituent elements that are identical to those of the cell assembly 100 according to the second embodiment shown in FIG. 6 are labeled with the same reference numeral, and description thereof is omitted.

The cell assembly 120 is formed by stacking a first fuel cell 122 and a second fuel cell 124 in a direction indicated by an arrow A. The cell assembly 120 does not have any intermediate oxygen-containing gas passage. The fuel gas flows from the first fuel cell 122 to the second fuel cell 124 through a fuel gas flow field 56 and a fuel gas flow field 52 which are connected in series together. The oxygen-containing gas flows through an oxygen-containing gas flow field 46 of the first fuel cell 122 and an oxygen-containing gas flow field 58 of the second fuel cell 124 individually, i.e., separately.

According to the solid polymer electrolyte fuel cell assembly of the present invention, coolant flow fields are be formed on opposite sides of the cell assembly, respectively, for supplying a coolant straight in one direction through the coolant flow fields. Alternatively, a coolant flow field extends through the cell assembly for supplying a coolant straight through the coolant flow field. Since the coolant flows through the coolant flow fields in the one direction smoothly, the cooling efficiency is good, and the temperature difference does not occur in the cell assembly, or between the cell assemblies. The power generation performance in the fuel cells is not degraded, and the desired power generation performance of the overall cell assembly is reliably maintained.

While the invention has been particularly shown and described with reference to preferred embodiments, it will be understood that variations and modifications can be effected thereto by those skilled in the art without departing from the spirit and scope of the invention as defined by the appended claims.

What is claimed is:

1. A solid polymer electrolyte fuel cell assembly formed by stacking a plurality of fuel cells together, said fuel cells each having a membrane electrode assembly including an anode, a cathode, and a solid polymer electrolyte membrane interposed between said anode and said cathode, wherein
reactant gas flow fields extend through said fuel cells, respectively, for supplying a reactant gas to said fuel cells, said reactant gas flow fields being connected in series at least partially, said reactant gas including at least one of a fuel gas and an oxygen-containing gas; and
wherein coolant flow fields are formed on opposite sides of said cell assembly, respectively, for supplying a coolant straight in one direction through said coolant flow fields.

2. A solid polymer electrolyte fuel cell assembly according to claim 1, wherein a wall plate is provided on at least one side of said cell assembly, and said coolant flow fields are formed on both surfaces of said wall plate, respectively, for supplying said coolant straight in one direction through said coolant flow fields.

3. A solid polymer electrolyte fuel cell assembly formed by stacking a plurality of fuel cells together, said fuel cells each having a membrane electrode assembly including an anode, a cathode, and a solid polymer electrolyte membrane interposed between said anode and said cathode, wherein
reactant gas flow fields extend through said fuel cells, respectively, for supplying a reactant gas to said fuel cells, said reactant gas flow fields being connected in series at least partially, said reactant gas including at least one of a fuel gas and an oxygen-containing gas; and
wherein a coolant flow field extends through said cell assembly for supplying a coolant straight through said coolant flow field.

4. A solid polymer electrolyte fuel cell assembly according to claim 3, wherein a first intermediate separator and a second intermediate separator are interposed between two of said fuel cells, and said coolant flow field extend between a surface of said first intermediate separator and a surface of said second intermediate separator for supplying said coolant straight through said coolant flow field.
